(19) United States
(12) Patent Application Publication
(10) Pub. No.: US 2010/0035025 A1
(43) Pub. Date: Feb. 11, 2010

(54) Color Matched Wood-Grained Component

(76) Inventors: Christian Kearney, Upper Arlington, OH (US); Cordell Bosma, Fargo, ND (US)

Correspondence Address: Capitol City TechLaw, PLLC, 113 S. Columbus St., Suite 302, Alexandria, VA, 22314, US

(21) Appl. No.: 12/538,316

(22) Filed: Aug. 10, 2009

Related U.S. Application Data
(60) Provisional application No. 61/087,303, filed on Aug. 8, 2008.

(51) Int. Cl. B32B 3/10; B32B 3/30; B05D 3/12

(52) U.S. Cl. 428/172; 428/195.1; 264/132

(57) ABSTRACT

Disclosed is an automotive vehicle interior component made of a plastic substrate having at least one flat surface with at least one adjacent curved surface which are covered with a wood-grained plastic film having a major color feature, and the plastic substrate is made from a plastic resin colored to match the major color feature of the wood-grained plastic film. A method of producing the vehicle interior component is also disclosed.

### RELATED APPLICATIONS

The present application claims benefit from earlier filed U.S. Provisional Application No. 61/087,303, filed Aug. 8, 2008, which is incorporated herein in its entirety by reference for all purposes.

### BACKGROUND

1. Field of the Invention

The present disclosure relates to a wood-grained component of an automotive vehicle interior containing a plastic substrate having at least one flat surface with at least one adjacent curved surface, and a wood-grained plastic film having a major color feature and covering at least one flat surface and at least one adjacent curved surface of the plastic substrate. The plastic substrate is made of a plastic resin composition which has been colored to match exactly, or as closely as possible, the major color feature of the wood-grained plastic film.

The present disclosure also relates to a method of producing a wood-grained component for the interior of an automotive vehicle by providing a plastic resin composition and a wood-grained plastic film having one major color feature present therein. Color additives are incorporated into the plastic resin composition to form a colored plastic resin composition which matches the major color feature of the wood-grained plastic film. The colored plastic resin composition is then formed into a substrate having a plurality of both flat and curved surfaces, with at least one curved surface adjacent a flat surface. The wood-grained plastic film is then applied to the flat surface and one adjacent curved surface.

2. Description of the Related Art

Real wood, or at least, the appearance of real wood, is a popular choice for the interior of luxury automobiles. However, incorporating real wood into automotive interior parts is an expensive process. Wood veneer is typically expensive and can use wood from ecologically sensitive areas of the world. Genuine wood paneling can only be applied in cases where the part geometry is very flat, and then only to the top surface of these parts. Accordingly, the sides or edges of the genuine wood paneling, which do not have the same grain pattern as the top surface, are revealed.

Thus, in order to achieve the desired appearance of a piece made entirely of wood the sides and edges of such interior pieces are carefully painted, typically by hand. This manufacturing process can be both costly and very time consuming.

Presently, film-based coatings can also be applied to the flat surfaces of plastic parts to provide a wood-grained appearance, however, here the sides or edges of the plastic part can also be seen. The appearance of the plastic part, the color of which differs from the film-based coating, provides an appearance that is not as appealing as desired.

A method of mimicking the appearance of a real wood interior part with film-based coatings and plastic parts without the need to apply paint, especially painting by hand, is of interest.

### SUMMARY OF THE PRESENT DISCLOSURE

The present disclosure is directed to a wood-grained component of an automotive vehicle interior made of a plastic substrate having at least one flat surface with at least one adjacent curved surface and a wood-grained plastic film having a major color feature applied to the substrate, and covering at least one flat surface and at least one adjacent curved surface of the plastic substrate. The plastic substrate can be made of a plastic resin composition colored to match the major color feature of the wood-grained plastic film.

The present disclosure also relates to a component of an automotive vehicle interior including a plastic substrate having at least one flat surface with at least one adjacent curved surface with a wood-grained plastic film having a major color feature and covering at least a portion of the flat surface of the plastic substrate. The plastic substrate can be made of a plastic resin colored to match the major color feature of the wood-grained plastic film.

A method of producing a wood-grained component for the interior of an automotive vehicle is also disclosed herein. The present method includes providing a plastic resin composition and a wood-grained plastic film having a major color feature present therein. Color additives are then incorporated into the plastic resin composition to form a colored plastic resin composition, so that the color of the colored plastic resin composition matches the major color feature of the wood-grained plastic film. The colored plastic resin composition is then formed into a substrate having a plurality of both flat and curved surfaces, and wherein at least one curved surface is adjacent a flat surface. The wood-grained plastic film is then applied to at least one flat surface and one adjacent curved surface of the substrate.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention.

In the drawings:

FIG. 1 is a line drawing of a wood veneer containing substrate, and

FIG. 2 is a line drawing of various embodiments of film-containing substrates according to the present disclosure.

### DETAILED DESCRIPTION OF THE PREFERRED EMBODIMENTS

The present teachings are directed to a component of an automotive vehicle interior made from a plastic substrate having at least one flat surface with at least one adjacent curved surface. A wood-grained plastic film having a major color feature covers at least one flat surface and at least one adjacent curved surface of the plastic substrate, and the plastic substrate is made from a plastic resin composition colored to match the major color feature of the wood-grained plastic film.

The component of the present teachings has no paint applied to it. Unlike parts that have genuine wood paneling applied thereto, there is no need for the expensive, time-consuming hand painting of the component.

The wood-grained plastic film can be an opaque wood-grained plastic film, or in some embodiments of the present disclosure, it can be a wood-grained plastic film with transparent portions therein.

The plastic substrate that makes up the component can have at least one flat surface. In some embodiments, the flat surface can be a recessed surface of the substrate, and in some embodiments, it can be a raised surface of the substrate. The wood-grained plastic film of the present disclosure can additionally cover more than at least one flat surface and at least one adjacent curved surface of the plastic substrate. Depending on the design criteria of the interior component the amount of the plastic substrate that is covered by the wood-grained plastic film will vary.

The wood-grained plastic film of the present disclosure can have a variety of colors present thereon, however it will have one major color or a major color feature present that can be used as the basis for matching the color of the plastic resin composition and the plastic substrate subsequently formed from the resin. The major color feature can be, in some embodiments, the predominant color of the visible surface of the wood-grained plastic film. In other embodiments, the major color feature can be at least about 50% of the visible surface area of the wood-grained plastic film, when applied to the interior substrate, or in some cases, being the color of at least about 60% of the visible surface area of the wood-grained plastic film, and in other cases, being the color of at least about 70% of the visible surface area of the wood-grained plastic film.

The plastic resin composition from which the plastic substrate of the present disclosure is formed can be any suitable plastic composition that meets the engineering criteria for the substrate and its end use. The plastic resin composition utilized in the present disclosure can include one or more of the following known plastic materials, for example, ABS (acrylonitrile butadiene styrenes, PP (polypropylene), ABS/PC (acrylonitrile butadiene styrene/polycarbonate) blends, PU (polyurethane), TPO (thermoplastic olefin), PET (polyethylene terephthalate) and PBT(polybutylene terephthalate), and mixtures thereof.

The wood-grained plastic film of the present disclosure can be composed of a variety of suitable plastic films including, for example, plastic films composed of at least one member selected from group consisting of polyacrylate, polyethylene, polystyrene, polyvinyl, and cellulose-based films, such as, cellulose acetate, methyl cellulose, and cellulose acetate butyrate.

The wood-grained plastic film of the present disclosure can be further coated with a suitable top coat of a protective coating layer. The protective coating layer can be composed of a variety of coating materials. The coatings can have additives incorporated therein to provide, for example, enhanced resistance to scratches, UV radiation, and IR radiation.

The plastic substrate of the present disclosure can be prepared in such a manner as to provide the appearance of having been painted. This appearance can be accomplished, for example, through the way in which the plastic substrate is molded, or in some cases, by the type and concentration of the color additives added to the plastic resin composition.

The present disclosure also includes a method of producing a component for the interior of an automotive vehicle by providing both a plastic resin composition and a wood-grained plastic film having a major color feature present. Color additives are then incorporated into the plastic resin composition to form a colored plastic resin composition, which is then formed into a substrate having a plurality of both flat and curved surfaces with at least one curved surface that is adjacent a flat surface. The previously provided wood-grained plastic film is then applied to or adhered to at least one flat surface and one adjacent curved surface of the substrate. The method further includes matching the color of the colored plastic resin composition to the major color feature of the wood-grained plastic film.

The method of the present disclosure can further include applying the wood-grained plastic film to more than at least one flat surface and one adjacent curved surface of the substrate. The substrate used in the method can also have the afore-mentioned flat surface being a recessed surface of the substrate, or in other embodiments, the flat surface can be a raised surface of the substrate. In yet other additional embodiments, the surface covered by the wood-grained plastic film can include both raised and recessed surfaces, and both flat and curved surfaces.

The wood-grained plastic film of the present disclosure can be applied to both flat and adjacent curved portions of the plastic substrate. Thus, the desirable wood-grained appearance extends to the sides and edges of the plastic substrate, and thereby eliminates the need to hand paint the sides and edges of the plastic substrate as occurs with the use of wood veneer.

The wood-grained plastic film used in the present method can be an opaque wood-grained plastic film, or in some embodiments, can be a wood-grained plastic film with transparent portions therein, which would allow the plastic substrate onto which it is applied to be seen. Such variables reflect the characteristics of the design criteria for the interior component.

In the presently disclosed method, the major color feature of the wood-grained plastic film can be the predominant color of the visible surface of the plastic film. In further embodiments of the present method, the major color feature of the wood-grained plastic film can encompass at least about 50% of the visible portion, or, at least about 60% of the visible portion of the wood-grained plastic film, or in some embodiments, can encompass at least about 70% of the visible portion of the wood-grained plastic film.

In the presently disclosed method, the plastic resin composition can be composed one or more of the following suitable plastic resins: ABS, PP, ABS/PC blends, PU, TPO, PET and PBT, and mixtures thereof.

The present disclosure also relates to a component of an automotive vehicle interior including a plastic substrate having at least one flat surface with at least one adjacent curved surface with a wood-grained plastic film having a major color feature and covering at least a portion of the flat surface of the plastic substrate. The plastic substrate can be made of a plastic resin colored to match the major color feature of the wood-grained plastic film.

As set forth above, the presently disclosed component can have no paint applied to it. Furthermore, the wood-grained plastic film can be an opaque wood-grained plastic film, or in some cases, can be a wood-grained plastic film with transparent portions therein.

The disclosed component can have the wood-grained plastic film covering more than at least a portion of the flat surface of the plastic substrate and at least a portion of the adjacent curved surface of the plastic substrate.

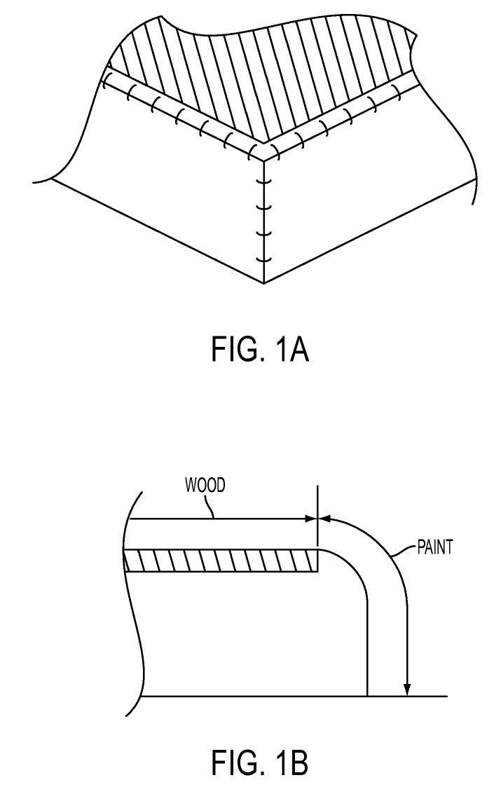

FIGS. 1A and B illustrates one possible substrate using real wood veneer inserted over the substantially flat portion of the substrate and having the edges of the veneer covered by the substrate. The substrate has paint applied to both the flat portion and an adjacent curved surface to match the real wood veneer.

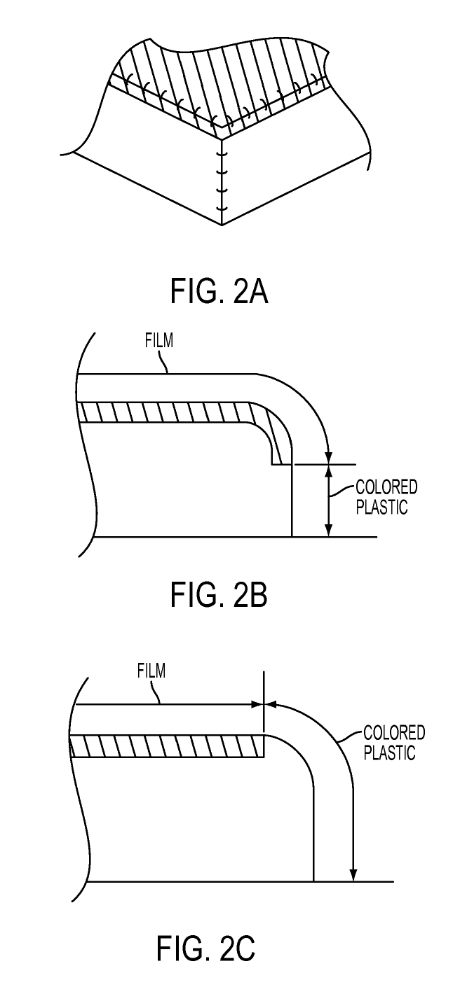

FIG. 2 illustrates some substrates according to the various embodiments of the present disclosure with a plastic film covering the flat surface and in one case (FIG. 2B) extending over and covering a portion of the adjacent curved surface, and in another case (FIG. 2C) having the plastic film ending before the curved surface and thus covering only the flat surface. The plastic substrate can include color components to substantially color match the major color feature of the wood-grained plastic film.

As used herein, a “color match” or “colored to match” describes a condition where the color of one object, for instance, the wood-grained plastic film, is the same as or equivalent to the color of another object, for instance, the substrate made of the colored plastic resin composition. The phrase “the same as or equivalent to” refers to a condition where the color of each object, as measured by an objective method, such as, the CIELAB or CIELCH methods, varies no more than about 10%, or in some cases varies by no more than about 5%, in other cases varies by no more than about 2%, and in yet other cases by no more than about 1%.

The process of matching the colors of the substrate and the films can also include a spectrophotometric measurement technique similar to that discussed in U.S. Pat. No. 7,116,420 B2 to Skierski et al.

As used herein, “colored plastic composition,” “colored plastic resin composition,” or “colored plastic substrate” refer to plastic compositions or substrates to which coloring additives or dyes have been added to or incorporated into, and does not refer to substrates that have been painted.

As used herein, “automotive” refers to, for example and without limitation, automobiles, trucks, motorcycles, all-terrain vehicles, personal watercraft, boats, and other self-propelled vehicles.

All publications, articles, papers, patents, patent publications, and other references cited herein are hereby incorporated herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What is claimed is:

1. A component of an automotive vehicle interior comprising:
a plastic substrate having at least one flat surface with at least one adjacent curved surface; and
a wood-grained plastic film having a major color feature and covering at least a portion of the flat surface and the adjacent curved surface of the plastic substrate,
wherein the plastic substrate is comprised of a plastic resin colored to match the major color feature of the wood-grained plastic film.

2. The component according to claim 1, wherein no paint is applied to the component.

3. The component according to claim 2, wherein the wood-grained plastic film comprises an opaque wood-grained plastic film.

4. The component according to claim 2, wherein the wood-grained plastic film comprises wood-grained plastic film with transparent portions therein.

5. The component according to claim 2, wherein the flat surface of the substrate comprises a recessed surface of the substrate.

6. The component according to claim 2, wherein the flat surface of the substrate comprises a raised surface of the substrate.

7. The component according to claim 2, wherein the wood-grained plastic film further covers more than the flat surface and the adjacent curved surface of the plastic substrate.

8. The component according to claim 2, wherein the major color feature of the wood-grained plastic film comprises at least about 60% of the visible portion of the wood-grained plastic film.

9. The component according to claim 2, wherein the major color feature of the wood-grained plastic film comprises at least about 70% of the visible portion of the wood-grained plastic film.

10. The component according to claim 2, wherein the plastic resin composition comprises at least one member selected from the group consisting of ABS, PP, ABS/PC blends, PU, TPO, PET, PBT, and mixtures thereof.

11. A method of producing a component for the interior of an automotive vehicle comprising:
providing a plastic resin composition;
providing a wood-grained plastic film having one major color feature present therein;
incorporating color additives into the plastic resin composition to form a colored plastic resin composition;
forming the colored plastic resin composition into a substrate having a plurality of both flat and curved surfaces, and wherein at least one curved surface is adjacent a flat surface; and
applying the wood-grained plastic film to at least one flat surface and one adjacent curved surface of the substrate;
wherein the color of the colored plastic resin composition matches the major color feature of the wood-grained plastic film.

12. The method according to claim 11, further comprising
applying the wood-grained plastic film to more than at least one flat surface and one adjacent curved surface of the substrate.

13. The method according to claim 11, wherein the wood-grained plastic film comprises an opaque wood-grained plastic film.

14. The method according to claim 11, wherein the wood-grained plastic film comprises wood-grained plastic film with transparent portions therein.

15. The method according to claim 11, wherein the flat surface of the substrate comprises a recessed surface of the substrate.

16. A component of an automotive vehicle interior comprising:
a plastic substrate having at least one flat surface with at least one adjacent curved surface; and
a wood-grained plastic film having a major color feature and covering at least a portion of the flat surface of the plastic substrate,
wherein the plastic substrate is comprised of a plastic resin colored to match the major color feature of the wood-grained plastic film.

17. The component according to claim 16, wherein no paint is applied to the component.

18. The component according to claim 16, wherein the wood-grained plastic film comprises an opaque wood-grained plastic film.

19. The component according to claim 16, wherein the wood-grained plastic film comprises wood-grained plastic film with transparent portions therein.

20. The component according to claim 16, wherein the wood-grained plastic film further covers more at least a portion of the flat surface of the plastic substrate and at least a portion of the adjacent curved surface of the plastic substrate.
